(19) United States
(12) Patent Application Publication
(10) Pub. No.: US 2010/0115242 A1
(43) Pub. Date: May 6, 2010

(54) ENGINE/PROCESSOR COOPERATION SYSTEM AND COOPERATION METHOD

(76) Inventor: Kenshin YAMADA, Tokyo (JP)

Correspondence Address: Mr. Jackson Chen, 6535 N. STATE HWY 161, IRVING, TX, 75039, US

(21) Appl. No.: 12/593,407

(22) PCT Filed: Mar. 17, 2008
(86) PCT No.: PCT/JP2008/054865

§ 371 Date: Oct. 12, 2009

(30) Foreign Application Priority Data
Mar. 29, 2007 (JP) 2007-089009

(51) Int. Cl. G06F 9/30

(52) U.S. Cl. 712/220; 712/E09.016

(57) ABSTRACT

To provide an engine software cooperation mechanism which avoids stopping the operation of a high-speed engine during timer monitoring processing. This system checks occurrence of a timeout event by directly accessing the content of a session data memory without regard to the locking state of a session. If detecting the state of timeout, the system requests execution of timeout processing via a timer transmission circuit. By timeout processing, the time of timeout and the present time are checked again to confirm whether a timer is not cancelled.

### TECHNICAL FIELD

The present invention relates to an engine processor cooperation system. Particularly, the present invention relates to an engine processor cooperation system that can execute time-out monitoring in parallel.

### BACKGROUND OF THE RELATED ART

In an arithmetic system that performs some arithmetic operation to an external input and issues some kinds of output, the configuration of the arithmetic system is roughly classified, as shown in FIG. 9. That is, the arithmetic system includes a reception section that receives data from outside, a transmission section that transmits data outside, and an arithmetic section that executes an arithmetic operation to data received from a reception section and outputs it to a transmission circuit.

The software arithmetic system using a processor, shown in FIG. 10, and the hardware arithmetic system, shown in FIG. 11 are generally quoted as an example of an arithmetic system.

The software arithmetic system is configured of reception circuits, transmission circuits, a processor, a memory, other peripheral devices, and processor bus for connecting respective modules. The software arithmetic system is a flexible architecture where the module compatible with processor bus standards can be arbitrarily added by connecting all modules via the processor bus.

However, such architecture requires that data are transmitted and received via the processor bus for an access among all modules, so that the arithmetic processing performance is low generally. Particularly, the processor itself performs processing through repetitive sequential access to the memory device.

For that reason, the software arithmetic system can generally realize various types of processes flexibly but is difficult to realize its high performance.

The hardware arithmetic system includes reception circuits, transmission circuits, and a hardware arithmetic processing section. The hardware arithmetic processing section inputs data received from a reception circuit directly to a hardware arithmetic portion and subjects it to an arithmetic process, thus outputting the outcome to a transmission circuit. Thus the transmission circuit outputs the transmission data externally.

Generally, the hardware arithmetic system, in which respective modules are connected fixedly together, can execute the process necessary for arithmetic operation through a parallel pipeline process, thus realizing a higher performance, compared with the software arithmetic system.

In contrast, the hard-wired process makes it difficult to construct a flexible system. Since the hardware arithmetic system requires a dedicated logic design, there are problems in terms of the circuit scale and the design period, so that it is difficult to realize a complicated logic.

As described above, each of the software arithmetic system and the hardware arithmetic system has drawbacks and advantages. Altera proposes an arithmetic system utilizing the advantages of both the systems.

FIG. 12 illustrates C2H of Altera as a conventional example 1 (non-patent document 1).

The arithmetic system of the conventional example 1 includes reception circuits, transmission circuits, a processor, a memory, a DMA engine, and a hardware engine.

Data input in a reception circuit is once expanded in the general-purpose memory of the processor. When deciding that the received data is processable by the hardware engine, the processor transfers data to be processed from the memory to the hardware engine, using the DMA engine. When receiving data to be processed, the hardware engine executes an arithmetic process to the corresponding data and transfers the arithmetic result to the memory, accessible from the processor, via the DMA engine.

Using the arithmetic system of the conventional example 1, a complicated process is performed using the processor while the hardware engine can realize a simple process, being a bottleneck of the processing. Thus, that system can satisfy both the flexibility of the processor and high-speed characteristic of the hardware engine.

However, the decision whether or not the hardware engine is used to the process input by a reception circuit, an indication of data transmission to the hardware engine, or the like, have to be executed via the processor. The processor process becomes essential in the case where the hardware engine is used. For that reason, the conventional example degrades its performance, compared with the case where only the hardware engine is used.

Moreover, when the time-out process is realized by the conventional example 1, the decision whether or not the hardware engine is used, indication for data transmission to the hardware engine, or the like, is executed via the processor. For that reason, the case where the hardware engine is used requires the processor process essentially, so that the system degrades its performance.

Non-patent document 1: Altera C2H

(http://www.altera.co.jp/products/ip/processors/nios2/tools/c2h/ni2-c2h.html,
http://www.altera.co.jp/products/ip/processors/nios2/benefits/performance/ni2-acceleration.html, http://www.altera.co.jp/literature//wp/wp-aghrdwr.pdf)

### DISCLOSURE OF THE INVENTION

### Problems to be Solved by the Invention

The present invention is concepted in view of the above-mentioned problems. The object of the present invention is to provide an engine processor cooperation system in which a processor performs arithmetic processing, not requiring complicated and high-performances and in which a hardware engine performs arithmetic processing, requiring simple and high performances. The engine processor cooperation system can continue a high-speed processing without stopping the operation of a hardware processing circuit so long as a time-out event does not occur, to realize a time-out monitoring process.

### Means to Solve the Problems

According to the present invention, which solves the above-mentioned problems, an engine processor cooperation system comprises a session data memory for managing session data, which are information regarding sessions, for each session; a read-out section for reading out session data of a session to which an entered command belong, from the session data memory; a storage section for storing the entered command and the session data; a hardware processing section including a process decision section and a high-speed engine, the process decision section deciding whether or not the entered command and the session data, which are stored, are processed by software or with a hardware processing section, based on the session data read out; the high-speed engine processing, when the process decision section has decided the processing in the hardware processing section, the entered command and further acquiring a current time and calculating a time-out time, thus setting the time-out time to the session data; and a software processing section for processing, when processing in the software processing section has been decided, the entered command, which are stored, and further acquiring a current time, and calculating a time-out time, thus setting a time-out time to the session data. The software processing section monitors a time-out time set to the session data and detecting an occurrence of time-out.

According to the present invention, which solves the above-mentioned problems, an engine processor cooperation method comprises the steps of reading out session data of a session, to which an entered command belongs, from a session data memory, the session data memory managing session data, which are information regarding sessions, for each session; storing the entered command and the session data; deciding whether or not the entered command stored and the session data are processed by software or with a hardware processing section, based on the session data read out; when processing by a hardware processing section has been decided in said process decision step, executing the process by the hardware processing section and when processing by a software processing section has been decided in the process decision step, executing the process by the software processing section; acquiring a current time and calculating a time-out time, thus setting the time-out time to the session data; and monitoring a time-out time set by the session data and detecting an occurrence of time-out.

### Effect of the Invention

According to the present invention, the session data is not subjected to the locking process during execution of the time-out monitoring process. By doing so, the present invention can carry out hardware processing without a degradation of performance, compared with the high-speed engine, as long as a time-out event does not occur actually.

### BRIEF DESCRIPTION OF THE DRAWINGS

FIG. 1 is a block diagram illustrating an engine processor cooperation system according to the present invention.

FIG. 2 is a block diagram illustrating a reception circuit.

FIG. 3 is a block diagram illustrating a transmission circuit.

FIG. 4 is a diagram explaining a flow of input data in a process by hardware.

FIG. 5 is a diagram explaining a flow of input data in a process by software.

FIG. 6 is a diagram explaining a flow of input data in a process by software.

FIG. 7 is a diagram explaining an example of an entry of a session data memory.

FIG. 8 is a diagram explaining an operational timing example in an engine processor cooperation system.

FIG. 9 is a block diagram illustrating a conventional arithmetic system.

FIG. 10 is a block diagram illustrating a conventional software arithmetic system.

FIG. 11 is a block diagram illustrating a conventional hardware arithmetic system.

FIG. 12 is a block diagram illustrating the conventional example 1.

### EXPLANATION OF SYMBOLS

1 Reception circuit
2 Transmission circuit
2-1 Session transmission circuit
2-2 External transmission circuit
2-3 Timer transmission circuit
3 Hardware processing section
4 Software processing section
5 Session memory management section
7 MUX circuit
6 Processor bus
8 Engine processor cooperation system
30 High-speed engine
31 Process selection section
32 Process management section
33 Timer section
40 Processor
41 Memory
42 Peripheral circuit
50 Session data memory
51 Session lock memory
52 Session data read-out processing section
53 Session data write-in processing section

### BEST MODE FOR CARRYING OUT THE INVENTION

In an engine processor cooperation system, according to the present invention, both a processor that processes with software and a high-speed engine that processes with hardware can capture a current time from a timer section.

While executing a sequential flow process in each session, each of the high-speed engine and the processor locks the corresponding session data and disenables the reading operation. Moreover, each of the high-speed engine and the processor calculates a time-out time of each timer, using a captured current time, and stores it into a session data memory.

To check each session for an occurrence of time-out, the processor reads out the time-out time of session data, regardless of the locked status of the session data and monitors the presence or absence of occurrence of a time-out.

The session data is not locked while the processor is reading the corresponding data. For that reason, each of the high-speed engine and the processor may terminate a sequence of flow process in each session during the reading of a time-out time, thus updating the session data. However, in the session memory management section, reading a time-out time is atomic. That is, when the update timing of session data and the read-out timing at a time-out time are contemporary, it is guaranteed that each of a time-out time before updating or a time-out time after updating is read.

As described above, in the engine processor cooperation system according to the present invention, the locking process is not performed to session data during execution of a time-out monitoring process. Accordingly, the hardware processing can be realized, without a deterioration of performance, compared with the high-speed engine, so long as a time-out event does not occur actually.

When confirming the occurrence of time-out through time-out monitoring, the processor performs the read-out of session via the timer transmission circuit, thus executing a time-out process. The processor may often update session data between a detection of time-out status and read-out of session. Accordingly, when session data for time-out processing is read out, the processor or the process selector re-checks for the occurrence of time-out. When monitoring a timer to be time-out processed is cancelled or the time-out time is reset, the time-out processing is cancelled. The present cancellation process allows discordance in the process to a corresponding session to be prevented, without locking the session at the timer monitoring.

The feature of the present invention will be explained in detail below by referring to the attached drawing.

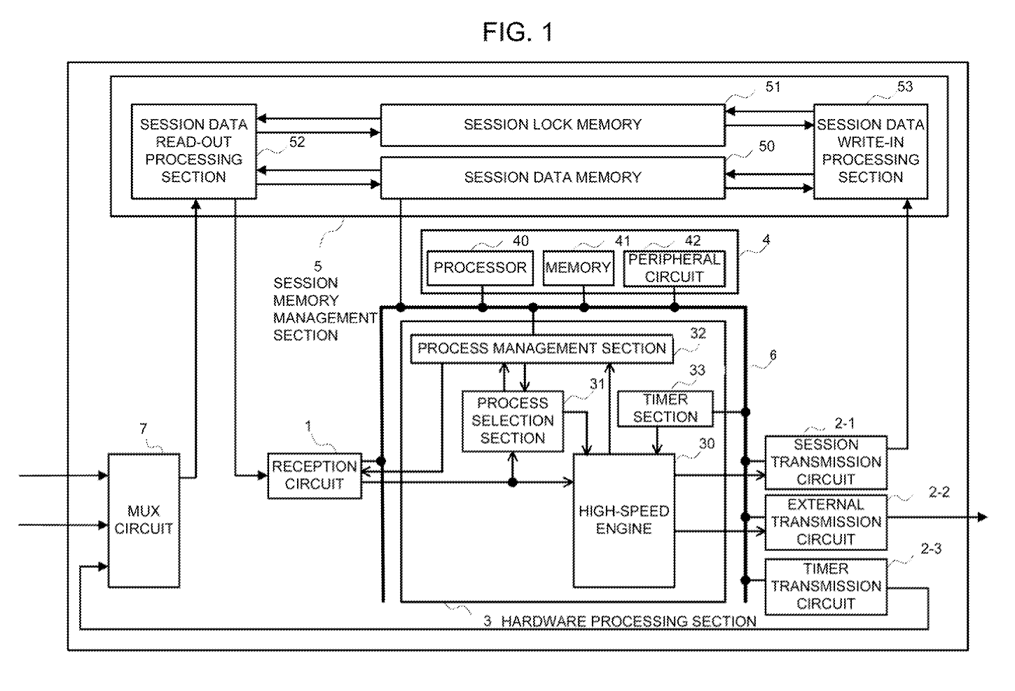

FIG. 1 illustrates the configuration of an engine processor cooperation system 8 in the best mode for carrying out the present invention.

The engine processor cooperation system 8 includes a reception circuit 1, transmission circuits 2 (a session transmission circuit 2-1, an external transmission circuit 2-2, and a timer transmission circuit 2-3), a hardware processing section 3, a software processing section 4, a session memory management section 5, a processor bus 6, and a MUX circuit 7.

The hardware processing section 3 includes a process selection section 31, a process management section 32, a high-speed engine 30, and a timer section 33.

The software processing section 4 includes a processor 40, a memory 41, and a peripheral circuit 42. The software processing section 4, connected to the processor bus 6, performs a software process via the processor bus 6.

The session memory management section 5 includes a session data write-in processing section 53, a session data read-out processing section 52, a session data memory 50, and a session lock memory 51.

The session memory management section 5 stores and manages inherent data (session data memory) of each session into the session data memory 50. Session data memory stored in the session data memory 50 is read out via the session data read-out processing section 52 and is updated via the session data write-in processing section 53.

The session lock memory 51 has the function for inhibiting access to the corresponding data of the session data memory 50 through the locking of session data. Specifically, the session data is locked during the period between the read-out of session data and an execution of a writing process. By doing so, even when the session data reading command to the same session is next received, the session data read-out processing section 52 waits for the reading of the session data in the corresponding session till the locking of the session data in the corresponding session is released.

Consequently, it can be prevented that a discordance of the session data occurs through reading out the session data in accordance with the next command of the same session before session data is updated after a termination of the previous command process. Moreover, the session data memory 50, connected to the processor bus 6, allows the processor 40 to have access to the session data of the session data memory 50.

The processor bus 6 is connected to the reception circuit 1, each transmission circuit 2, the processor 40, the memory 41, the peripheral circuit 42, the process management section 32, and session data memory 50. By doing so, the processor 40 can have access to each block to execute the software process.

The MUX circuit 7 selects one command, among from packets and commands, externally received, and commands, received from the timer transmission circuit 2-3, and transfers it to the session memory read-out processing section 52. There are, as a data reading method, the method of fixedly determining a priority order, a method of determining in round-robin fashion, and the method of reading in accordance with a reading ratio. The present invention may use any one of them.

When the session data read-out processing section 52 receives a command from the MUX circuit 7, the session lock memory 51 checks the locked status of the corresponding session. If data is not locked, the process of reading out the session data of the corresponding session from the session data memory 50 is performed. If the corresponding session data is locked, the read-out from the session data memory 50 is ceased till the locking is released. When the session memory write-in processing section 53 receives a command (update information) from the session transmission circuit 2-1, the locking of the corresponding session data is released.

When completing the read-out of session data, the session data read-out processing section 52 transfers it to the reception circuit 1, together with the content of the reception command (packet command data).

The reception circuit 1 temporarily holds data input from the session data read-out processing section 52.

The reception circuit I provides an interface capable of reading command data and session data, received, out of both the hardware processing section 3 and the software processing section 4.

The process selection section 31 refers command data and session data, stored in the reception circuit 1, and decides the process by the high-speed engine 30 or the processor 40.

When the process by the high-speed engine 30 is decided, the process selection section 31 notifies the high-speed engine 30 of the decided operation. The high-speed engine 30 reads out and processes the command data and the session data, sent from the reception circuit 1, and then transmits the execution result to each transmission circuit 2.

When the process selection section 31 decides the process by the processor 40, the processor 40 identifies the command process to be processed by its own via the process management section 32 and executes the command process, thus issuing the execution result to each transmission circuit.

The transmission circuit 2-1 is connected to the session data write-in processing section 53. The processor 40 or the high-speed engine 30 outputs, as the result of the executed command process, information on updated session data to the transmission circuit 2-1.

The session transmission circuit 2-1, connected to the session data write-in processing section 53, receives the result processed by the processor 40 or the high-speed engine 30 and outputs updated information on session data to the session transmission circuit 2-1.

The session data write-in processing section 53 updates the session data memory 50, based on updated information of the session data from the session transmission circuit 2-1, and releases the locking state of the session lock memory 51.

The processor 40 processes command data and session data, temporarily, held in the reception circuit 1, and further performs a timer monitoring process. When a time-out event occurs, the processor 40 transmits commands via the timer transmission circuit 2-3. The timer transmission circuit 2-3 transmits a command to the MUX circuit.

Here, detailed explanation will be made below as to the reception circuit 1.

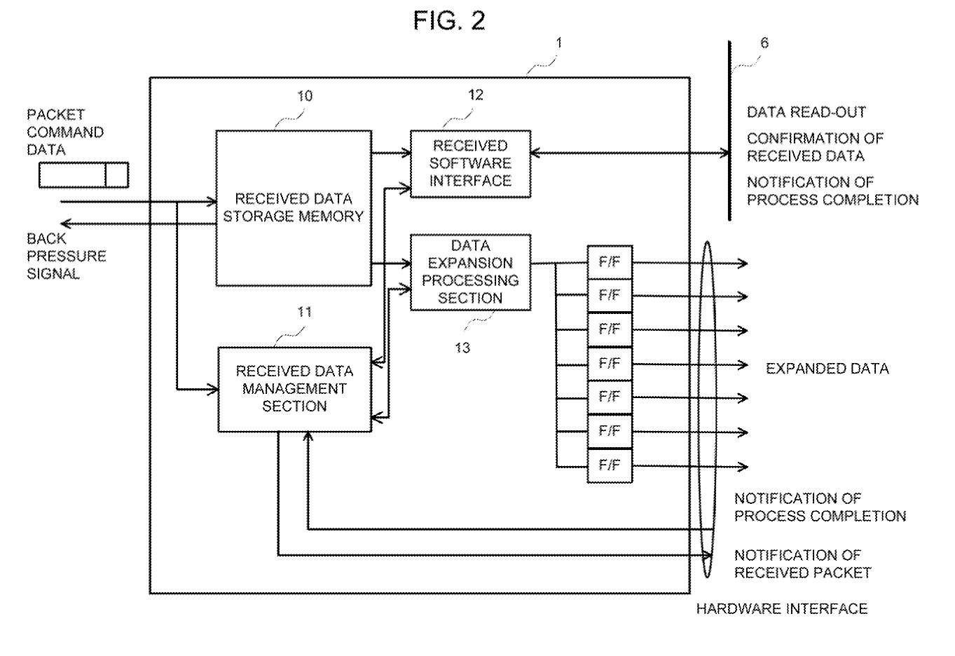

FIG. 2 shows the configuration of the reception circuit 1.

The reception circuit 1 includes a received data storage memory 10, a received data management section 11, a reception software interface 12, and a data expansion processing section 13.

The received data storage memory 10 stores packet command data and session data (input data), input in the reception circuit 1.

The received data management section 11 manages input data stored in the received data storage memory 10.

The reception circuit 1 includes a hardware interface and a software interface, each acting as means for reading input date stored in the received data storage memory 10.

The data expansion processing section 13 reads out input data input in the received data storage memory 10 as data to be read out, and expands the read-out data in a format accessible at a time from the hardware interface. When the input data is expanded, the received data management section 11 outputs a received packet notification signal to the hardware interface. Moreover, when the hardware completes its processing operation and receives a process completion notification from the hardware interface, it recognizes the fact that data to be read out has completely processed and discards the data to be read out. The received data management section 11 monitors the received data storage memory 10 till it receives a process completion notification from the hardware interface. When the next data to be read out exists, the received data management section 11 reads out and expands the next data to be read out from the received data storage memory 10.

The received software interface 12 can access input data stored in the received data storage memory 10 to the software processing section 4 via the processor bus 6. The received software interface 12 provides means for notifying the received data storage memory 10 whether or not data to be read out exists, read access means to the length of data to be read out and data to be read out when read-out data exists, and means for notifying the received data management section 11 of the fact that data to be read out has been completely processed from the software processing section 4 to the reception circuit 1.

As described above, the reception circuit 1 provides access means for accessing both the hardware interface and the software interface as to data to be read out exists or for accessing the data length and data to be read out when the corresponding data exists and means for notifying the reception circuit 1 of the face that data to be read out has been completely processed.

Subsequently, an explanation will be made below as to the transmission circuit 2-1.

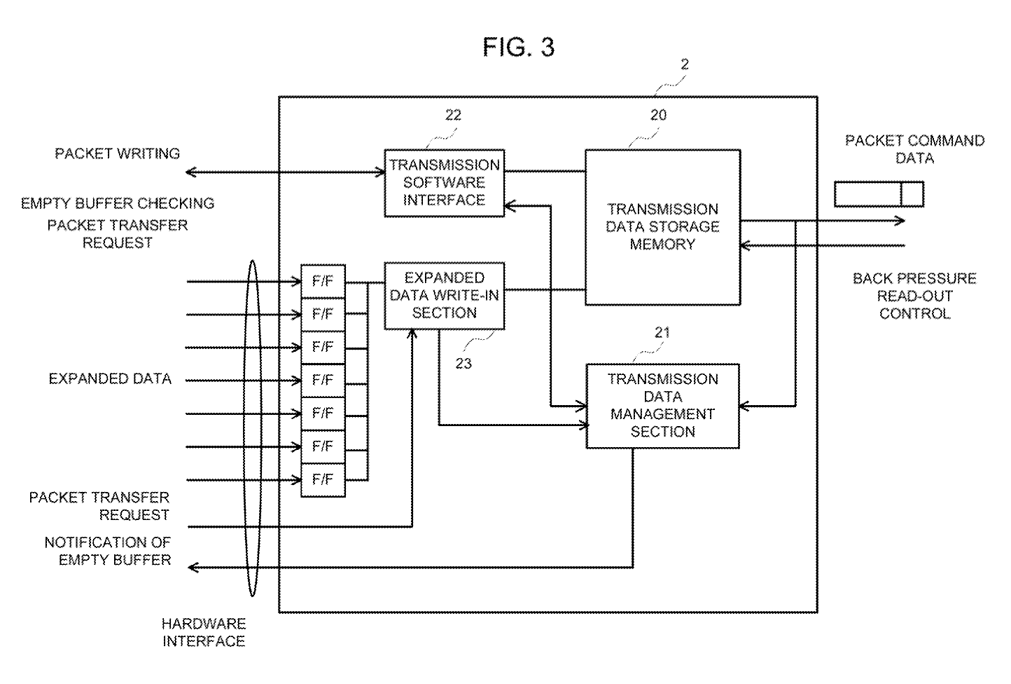

FIG. 3 shows the configuration of the transmission circuit 2-1.

The transmission circuit 2-1 includes a transmission data storage memory 20, a transmission data management section 21, a transmission software interface 22, and an expanded data writing section 23.

The transmission circuit 2-1 temporarily stores input data transmitted from the hardware interface or the software interface into the transmission data storage memory 20 and outputs the input data in accordance with a notification signal as to whether or not the input data can be received externally. As to the notification signal representing whether or not input data can be received externally, there are the method for finely controlling data reading externally and the method for notifying that a notification signal cannot be received based on a back pressure signal only when the outside cannot receive the command. The present invention may utilize any one of the two methods.

The transmission data management section 21 manages a data storage volume of the transmission data storage memory 20 and an access management of the transmission data storage memory 20. The transmission data management section 21 notifies both the hardware interface and the software interface 22 of an unoccupied buffer volume of the transmission data storage memory 20.

The high-speed engine 30 notifies of a transmission of transmission data via the hardware interface. The high-speed engine 30 previously expands input data to be transmitted and prepares it as expanded data. When the expanded data has been completely prepared, the high-speed engine 30 compares the data length of data to be transmitted and an unoccupied buffer volume already notified. When the unoccupied buffer volume is larger than the data length of the data to be transmitted, the high-speed engine 30 notifies of a packet transfer corresponding to the data length of data to be transmitted.

When receiving the packet transfer notification, the expanded data writing section 23 writes the expanded data into the transmission data storage memory 20. Normally, since the data width that can be written at once in the transmission data storage memory 20 is smaller the data width of the expanded data, the expanded data is written with a plurality of clocking.

The transmission data management section 21 guarantees that the writing of the next expanded data is inhibited while the expanded data writing section 23 is writing expanded data in the transmission data storage memory 20. In one embodiment, the hardware interface and the transmission software interface 22 are notified of an unoccupied buffer notification amount of zero during a data writing operation of the expanded data writing section 23, so that an occurrence of a new access request is inhibited.

The transmission software interface 22 is an interface for requiring the software processing section 4 to transfer transmission data via the processor bus 6. The transmission software interface 22 includes means for confirming an unoccupied buffer volume of the transmission data storage memory 20, means for setting the content of transmission data, and means for requiring a transmission of transmission data.

As described above, the transmission circuit 2-1 provides both the hardware interface and the software interface with means for confirming an unoccupied buffer volume of transmission data storage memory 20, means for setting the content of data to be transmitted, and means for requiring actual transmission of data.

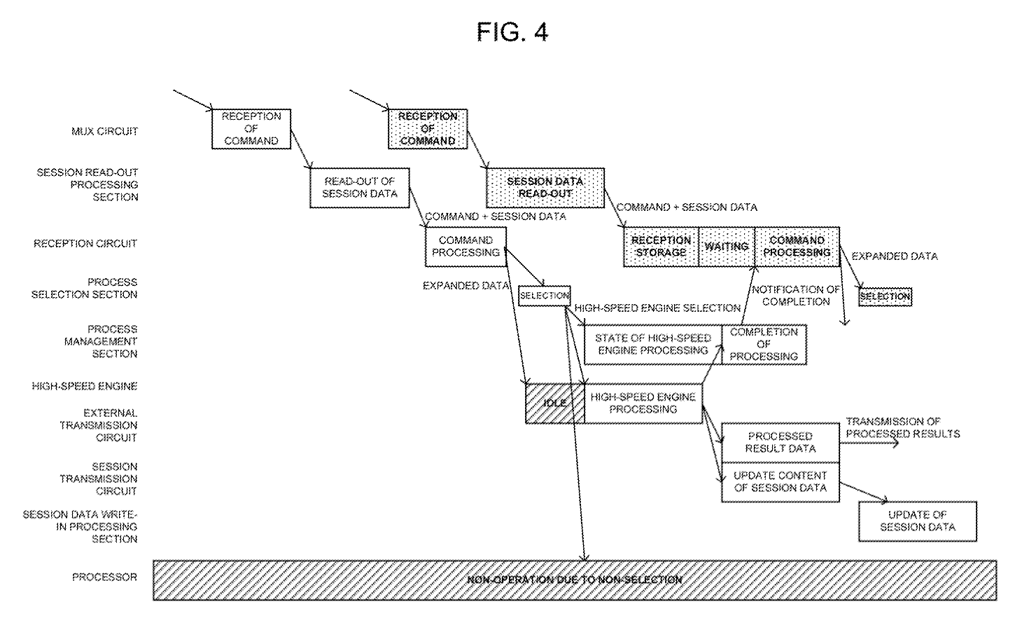

Next, a received command processing operation of the engine processor cooperation system 8, according to the present invention, will be explained below. FIG. 4 is a diagram explaining a flow of received commands when the high-speed engine 30 processes an input -received command.

First, an operational example where the high-speed engine 30 processes a received command will be explained below.

When receiving packet command data, the MUX circuit 7 transfers the command to the session data read-out processing section 52.

The session data read-out processing section 52 reads out session data from the session data memory 50 and thus sends it to the reception circuit 1.

In reception to the packet command data, the reception circuit 1 notifies the process selection section 31 of the packet reception.

The process selection section 31 refers to the received data and judges whether or not the high-speed engine 30 or the software processing section 4 executes processing, based on a predetermined arithmetic rule and in accordance with, for example, the session status described in the session data. Thus, the process selection section 31 notifies the process management section 32 of the resultant decision.

The process management section 32 selects the process by the high-speed engine 30 and notifies the software processing section 4 that the command to be processed by the software processing section 4 does not exist when the software processing section 4 checks the status of the process management section 32.

The process selection section 31 notifies the high-speed engine 30 of the received data to be processed by the high-speed engine 30. Then, the high-speed engine 30 executes an arithmetic process to the received data and decides data to be transmitted, based on the arithmetic result, thus sending a notification about data transmission to each transmission circuit. The arithmetic process includes the setting, releasing, and updating of a time-out time. The high-speed engine 30 acquires a current time from the timer section 33 and calculates a time-out time for a timer necessary for setting to update the session data.

After a completion of data transmission notification, the high-speed engine 30 notifies the process management section 32 that the process by the high-speed engine 30 has been completed. However, in the system to which it is determined that the process in the high-speed engine 30 completes in a fixed cycle, the process management section 32 may autonomously recognize a completion of the process of the high-speed engine 30.

The process management section 32 recognizes that current data to be processed has been completed and notifies the reception circuit 1 and the process selection section 31 of a completion of the command process.

When receiving a command process completion notification, the reception circuit 1 confirms whether or not the next command is in a storage state. When the next command is in a storage state, the data expansion processing section 13 again expands the received data, then notifying the process selection section 31 of packet reception.

In the engine processor cooperation system 8 according to the present invention, the software processing section 4 executes a slow software process. When the high-speed engine 30 processes the received data, the high-speed engine 30 performs a high-speed process through a hardware operation, without passing through the slow software processing section 4 (without going through a software process).

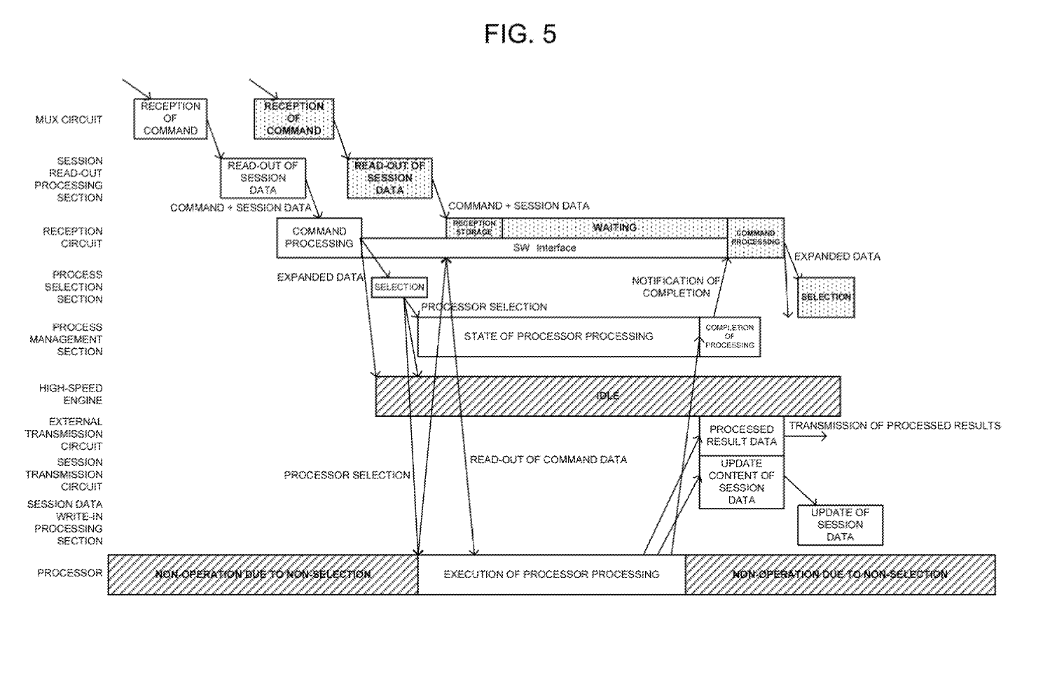

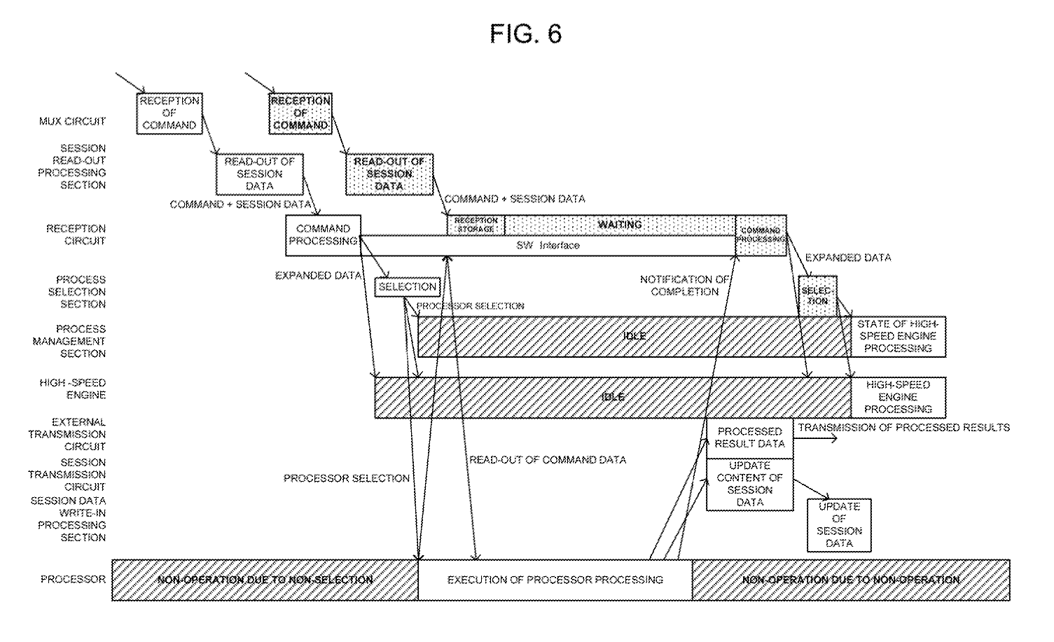

Subsequently, an operational example where the software processing section 4 processes received command will be shown below. FIG. 5 and FIG. 6 are diagrams, each explaining a received command flow when the processor 40 processes a received command. FIG. 5 is a diagram illustrating the case where the processor 40 notifies the reception circuit 1 of a completion of process via the process management section 32. FIG. 6 is a diagram illustrating the case where the processor 40 transmits a notification of process completion directly to the reception circuit 1.

When receiving packet command data, the MUX circuit 7 transfers the command to the session data read-out processing section 52. The session data read-out processing section 52 reads out session data of a corresponding session from the session data memory 50 and then outputs it to the reception circuit 1.

The reception circuit 1 implements an operation similar to that described above. That is, the reception circuit 1 receives the packet command data and the session data and notifies the process selection section 31 of them. The process selection section 31 judges whether to select the high-speed engine 30 or the software processing section 4, and then notifies the process management section 32 of the resultant decision.

When receiving a notification that data is to be subjected to a software process, from the process selection section 31, the process management section 32 changes the process state into a software processable state.

The processor 40 in the software processing section 4 reads out the process status register in the process management section 32 via polling and via the processor bus 6 and thus recognizes that the objective data is the command to be executed in the software processing section 4.

The processor 40 reads out the packet command data and the session data from the reception circuit 1 and executes a necessary arithmetic operation. The arithmetic operation includes the setting, releasing, and updating of a time-out time. The processor 40 acquires a current time from the timer section 33 and calculates a time-out time for a timer necessary for setting to update the session data.

After the arithmetic operation, the processor 40 notifies the reception circuit 1, which has processed the objective data, of a completion of the process, via the processor bus 6 or the process management section 32 and notifies each transmission circuit 2 of a transmission process of necessary commands.

When a completion of process is notified via the processor bus 6, the processor 40 notifies the process management section 32 of a completion of the objective data process.

When receiving a notification about a completion of an objective data sent from the software processing section 4, the processor management section 32 makes the process state register in an idle state and notifies the process selection section 31 that the next command can be processed.

Next, an operation of the time-out monitoring process in the engine processor cooperation system 8, according to the present invention, will be explained below.

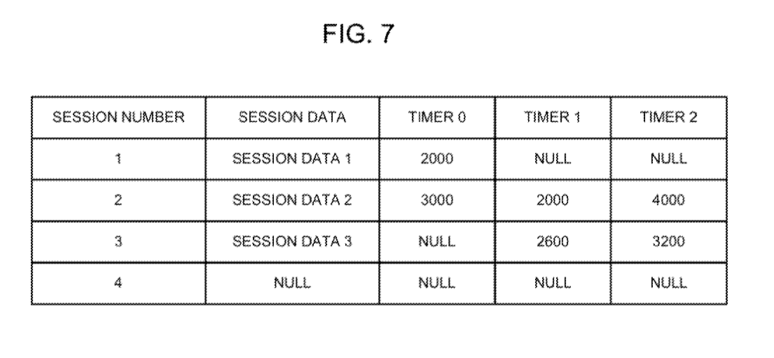

FIG. 7 is a diagram explaining an example of a session entry of session data held in the session data memory 50. The session data holds information inherent to session, such as a session state, in addition to the session entry.

The session entry of session data in the session data memory 50 stores session data itself and time-out time of various types of timer, for each session number. In the example in FIG. 7, it is assumed that three types of timer, including timer 0, timer 1 and timer 2, are operating.

The processor 40, which has a timer monitoring function, executes a timer monitoring process for each fixed period. The timer monitoring function of the processor 40 will be explained below.

The processor 40 acquires a current time from the timer section 33.

The processor 40 accesses the session data memory 50 and refers to a session entry of session data in use. Thus, the processor 40 checks whether or not any one of the timers 0, 1, and 2 has a value smaller than a current time, that is, whether or not a timer event has occurred.

When the session in which a time-out event has occurred exists, the processor 40 executes a time-out process.

In succession, the time-out process will be explained below. The time-out process is executed in accordance with the following procedure.

The processor 40 merely notifies the timer transmission circuit 2-3 of a transmission of a time-out process command to the session, in which the time-out has occurred.

The timer transmission circuit 2-3 transmits the time-out process command to the MUX circuit 7. The MUX circuit 7 transmits the command to the session data read-out processing section 52. The following operation is similar to that in the reception command process described above. The high-speed engine 30 or software processing section 4 carries out the time-out process to the corresponding session.

The time-out process by the high-speed engine 30 or the software processing section 4 depends on information regarding a time-out, such as an occurrence frequency of a time-out event, a complexity of processing, and a required process performance. Since the time-out event does not often occur and the process is exceptional and complicated, the setting is made in such way that the software processing section 4 executes. In contrast, in a time-out monitoring process in which a time-out event occurs comparatively often or in the situation where the deterioration of the performance realized with the high-performance processing by the high-speed engine 30 is unwanted, the setting is made in such way that the high-speed engine 30 executes the time-out process.

Next, the operation where the time-out process is executed with the software process will be explained below.

The process selection section 31 refers to packet command data and session data, which are output from the reception circuit 1, identifies a request command for a time-out process and notifies the process management section 32 of an object to be processed by the processor 40.

The processor 40 accesses the process management section 32 and checks time-out time information within the command in the reception circuit 1, upon identifying the command to be processed by the processor 40. When a time-out event occurs, or a current time exceeds the time-out time of a specific timer, the processor 40 executes a time-out process to the corresponding timer.

When any timer does not issue a time-out event, the time-out process is cancelled. A cancellation of the time-out process is realized through inhibiting commands from the external transmission circuit 2-2 to the outside, without updating the session information. Here, the session information is not updated but the read-out of a corresponding session is in a locked state. For that reason, the processor 40 transmits a release request command, which releases the locking to the read-out of the corresponding session, via the session transmission circuit 2-1.

In the timer monitoring, when a time-out process is carried out actually regardless of a detection of a time-out state, the time-out status may be released. The reason is that an entry of the corresponding session in the session data memory 50 is updated between a detection of a time-out status and the beginning of execution of a time-out process.

Locking the session entry of the corresponding session at the time of time-out monitoring does not lead to the above-mentioned problem. However, when the session entry is locked, the high-speed engine 30 cannot carry out the corresponding session during the locked state so that the process performance may degrade or the process delay may fluctuate.

According to the present invention, the engine processor cooperation system 8 detects a time-out at the time of time-out monitoring, without locking the session entry, locks the session entry when the time-out processing is performed actually, and again checks whether or not the time-out event has occurred. By doing so, the session entry is matched.

Next, explanation will be made as to the operation where the processor 40 or the high-speed engine 30 executes a time-out process selectively, based on the type of timer.

The process selection section 31 refers to the command output from the reception circuit 1, identifies a request command for a time-out process, and further checks the process condition of the high-speed engine 30.

The process condition of the high-speed engine 30 is, for example, an occurrence of timer-out in the timer 2 or an occurrence of timer-out in the timer 3, wherein time-out does not occur in the timer 2 and 3 at the same time.

In the above example, if the timer 2 or 3 issues a time-out, the high-speed engine 30 executes the time-out process. Under other conditions, when the timer 1, for example, issues a time-out, both the timers 2 and 3 issue a time-out, or an abnormal process where both of them do not issued a time-out occurs, the processor 40 executes the time-out process.

Next, explanation will be made as to the operation where the processor 40 or the high-speed engine 30 is selected based on the type of timer to execute a time-out process but where the high-speed engine executes an abnormal process, in which no timer issues a time-out.

The process selection section 31 refers to a command output from the reception circuit 1, identifies a request command for a time-out process, and further checks the process condition of the high-speed engine 30.

The process condition of the high-speed engine 30 is, for example, that the timer 2 issues a time-out or any timer does not issue a time-out.

When the time-out of the timer 2 occurs, the high-speed engine 30 performs a time-out process to the timer 2. When any timer does not issue time-out, the high-speed engine 30 transmits a lock release request command for the corresponding session to the session data write-in processing section via the session transmission circuit 2-1 to cancel the time-out process.

Next, the operational timing of the engine processor cooperation system 8 will be explained below.

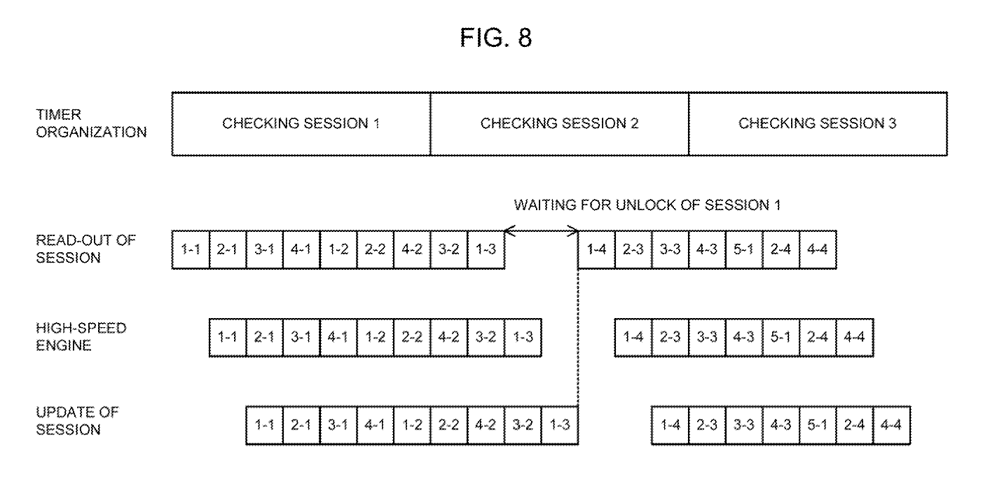

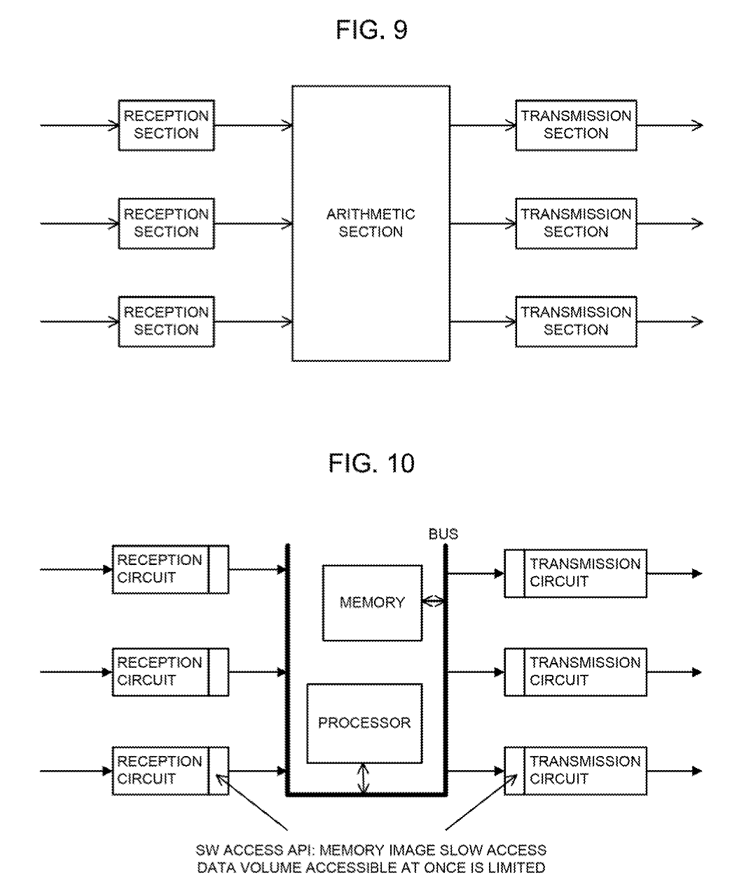

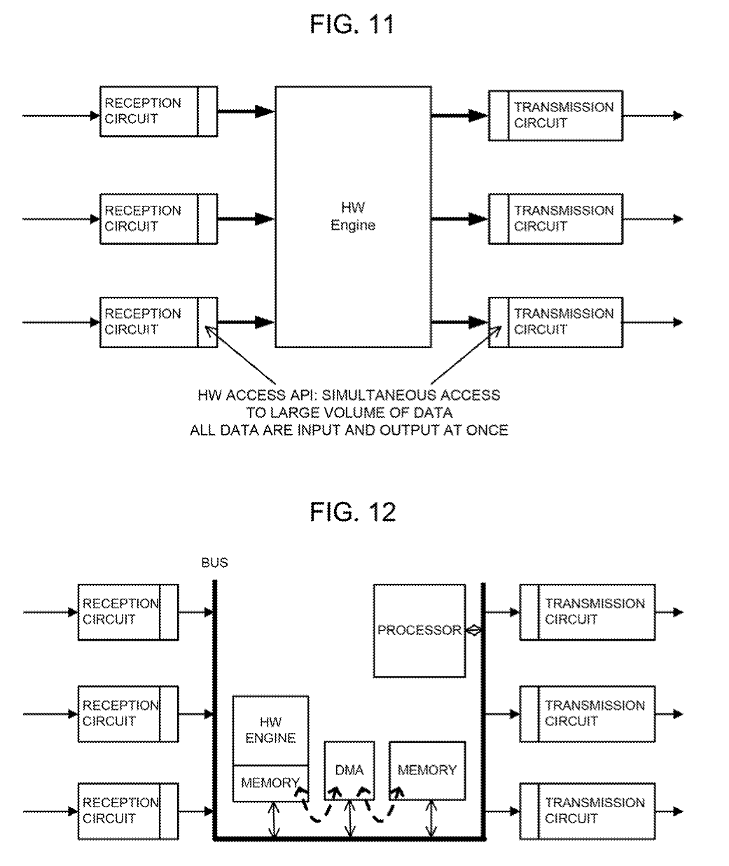

FIG. 8 illustrates the operational timing of the engine processor cooperation system 8.

Packet command data input to the MUX circuit 7 is executed in the order of the process of the session read-out processing section 52, the process of the high-speed engine 30, the process of the session data write-in processing section 53, and the like.

The number in each process shown in FIG. 8 means a session number and a packet number. For example, 1-2 corresponds to the second packet belonging to the session number 1.

The software processing section 4 executes the timer monitoring process. Accordingly, the speed of timer monitoring process generally is slower than that in a session read-out process executed by the hardware processing section 3, an arithmetic process in the high-speed engine 30, or a update process of session data in the session data write-in processing section 53. In the example, FIG. 8 illustrates the case where the processing time of the software processing section 4 is seven times than that of the process of the high-speed engine 30. In an actual process, it is not rare that the processing speed varies several ten times to several hundred times.

In the engine processor cooperation system 8 of the present invention, the locking process to the session data memory is not performed to realize timer monitoring of the session 1. Therefore, it is unnecessary to cease the process of the high-speed engine 30 to the command of the session 1 received during timer monitoring in the session 1. Therefore, the phenomenon can be prevented that an influence due to timer monitoring leads to a degradation of performance, an increase of a process delay amount, or a fluctuation of a process delay amount.

In the engine processor cooperation system of the present invention, described above, each of the processor and the high-speed engine includes a timer section that can capture a current time. Upon an execution of a session process, each of the high-speed engine and the processor calculates a time-out time of each timer, using the current time and then stores it into the session memory. In order to check each session for an occurrence of time-out, the processor reads a time-out time in a session entry, regardless of a locked state of session data, and confirms whether or not a time-out has occurred. Because the corresponding session data is not locked, session information may be updated during the reading of a time-out time. However, in the session memory management section, the reading of the time-out time is atomic. That is, when the update timing of session data is nearly the same as the read-out timing of time-out time, it is guaranteed that the time-out time before updating or the time-out time after updating is read in. In the engine processor cooperation system of the present invention, described above, session data is not locked during an execution of time-out monitoring process. Therefore, compared with the high-speed engine, the hardware process can realize the hardware process without a degradation of performance, so long as a time-out event does not occur actually.

Moreover, when confirming an occurrence of time-out through time-out monitoring, the processor performs the reading of session and a time-out process, via the timer transmission circuit. The processor may update session data between a detection of a time-out state and a read-out of session.

When session data for time-out processing is read out, the processor or the process selection section re-checks whether or not a time-out has occurred. When timer monitoring of a timer to be time-out processed is cancelled or a time-out time is reset, the operation of the time-out process is cancelled.

The present canceling process can prevent a mismatch of the process to a corresponding session, without locking the session at the time of timer monitoring.

The present application claims the priority rights based on Japanese Patent application No. 2007-089009 filed on Mar. 29, 2007 and the entire of the disclosure is incorporated here.

1. An engine processor cooperation system comprising:
a session data memory for managing session data, which are information regarding sessions, for each session;
a read-out section for reading out session data of a session to which an entered command belong, from said session data memory;
a storage section for storing said entered command and said session data;
a hardware processing section including a process decision section and a high-speed engine, said process decision section deciding whether or not said entered command and said session data, which are stored, are processed by software or with a hardware processing section, based on said session data read out; said high-speed engine processing, when said process decision section has decided the processing in said hardware processing section, said entered command and further acquiring a current time and calculating a time-out time, thus setting said time-out time to said session data; and
a software processing section for processing, when processing in said software processing section has been decided, said entered command, which are stored, and further acquiring a current time, and calculating a time-out time, thus setting a time-out time to said session data;
said software processing section monitoring a time-out time set to said session data and detecting an occurrence of time-out.

2. The engine processor cooperation system of claim 1, further comprising a time-out command transmission section for transmitting a time-out command, for execution of a process regarding a time-out, to said read-out section when said software processing section detects time-out.

3. The engine processor cooperation system of claim 1, wherein said read-out section sets inhibition of read-out, so as not to read out session data of a session, to which the entered command belongs, while said high-speed engine or said software processing section is processing said entered command, which is stored.

4. The engine processor cooperation system of claim 3, wherein said process decision section decides processing in said software processing section when said entered command is said time-out command; and wherein said software processing section compares a current time and said set time-out time, upon the processing of a time-out command, and monitors an occurrence of time-out, and releases said setting of read-out inhibition when a time-out does not occur.

5. The engine processor cooperation system of claim 3, wherein, when said entered command is said time-out command, said process decision section compares a current time and said set time-out time, and monitors an occurrence of time-out, and wherein when the time-out has not occurred, said process decision section decides that said software processing section processes the entered command.

6. The engine processor cooperation system of claim 3, wherein when said entered command is said time-out command, said process decision section compares a current time and said set time-out time, and monitors an occurrence of time-out; and wherein when the time-out has not occurred, said high-speed engine releases said setting of read-out inhibition.

7. The engine processor cooperation system of claim 4, wherein when said setting of reads-out inhibition is released, the session data is not updated.

8. An engine processor cooperation method comprising the steps of:
reading out session data of a session, to which an entered command belongs, from a session data memory, said session data memory managing session data, which are information regarding sessions, for each session;
storing said entered command and said session data;
deciding whether or not said entered command stored and said session data are processed by software or with a hardware processing section, based on said session data read out;
when processing by a hardware processing section has been decided in said process decision step, executing the process by said hardware processing section and when processing by a software processing section has been decided in said process decision step, executing the process by said software processing section;
acquiring a current time and calculating a time-out time, thus setting said time-out time to said session data; and
monitoring a time-out time set by said session data and detecting an occurrence of time-out.
